(19) United States
(12) Patent Application Publication
(10) Pub. No.: US 2022/0128030 A1
(43) Pub. Date: Apr. 28, 2022

(54) A METHOD FOR COMPUTER-IMPLEMENTED MONITORING OF A WIND TURBINE

(71) Applicant: Siemens Gamesa Renewable Energy A/S, Brande (DK)

(72) Inventors: Kartik Chandrasekhar, Sheffield (GB); Elizabeth Cross, Sheffield (GB); Nikolaos Dervilis, Sheffield (GB); Keith Worden, Sheffield (GB)

(21) Appl. No.: 17/427,339

(22) PCT Filed: Feb. 7, 2020
(86) PCT No.: PCT/EP2020/053145

§ 371 Date: Jul. 30, 2021

(30) Foreign Application Priority Data
Feb. 8, 2019 (EP) 19156230.5

(51) Int. Cl. F03D 7/04; F03D 7/02; G07C 3/08; G06N 20/00; G06K 9/62

(52) U.S. Cl. CPC F03D 7/046; F03D 7/0272; G06K 9/6256; G07C 3/08; G06N 20/00; F03D 7/0276

(57) ABSTRACT

A method for monitoring a wind turbine where for each blade an activity signal is detected at subsequent time points, where for each time point predicting an activity signal of each blade at the respective time point by a separate data-driven model, where the predicted activity signal is an output value of the respective data-driven model and where one or more detected activity signals of blades other than the blade whose activity signal is the output value are input values of the respective data-driven model; b) determining for each data-driven model a residual between the predicted activity signal and the detected activity signal; checking a threshold criterion for one or more variables, where the values of the one or more variables depend on the residuals for all data-driven models determining an abnormal operation state of the turbine, if the threshold criterion is fulfilled, is provided.

### CROSS-REFERENCE TO RELATED APPLICATIONS

This application is a national stage entry of PCT Application No. PCT/EP2020/053145 having a filing date of Feb. 7, 2020, which claims priority to European Patent Application No. 19156230.5, having a filing date of Feb. 8, 2019, the entire contents of which are hereby incorporated by reference.

### FIELD OF TECHNOLOGY

The following refers to a method and a system for computer-implemented monitoring of a wind turbine, and lies in the field of structural health monitoring in order to determine the condition of a structure.

### BACKGROUND

With respect to wind turbines, it is known that one method of diagnosing the state of the turbine is by the analysis of the vibrations of the rotating blades.

Document US 2010/0209243 A1 describes a method for monitoring blade frequencies of a wind turbine where the blade frequencies are extracted by analyzing the signals of an acceleration sensor positioned within the nacelle of the wind turbine. In this monitoring method, frequency differences between the blade frequencies of different blades are calculated and, in the case that one or more of the relative frequencies exceed a preset threshold, an alarm is generated.

### SUMMARY

It is an aspect of the present invention to provide a method and a system for computer-implemented monitoring of a wind turbine resulting in an enhanced detection of an abnormal behavior of the turbine.

The present invention provides a method for computer-implemented monitoring of a wind turbine, where the wind turbine comprises a tower, a nacelle, a hub and a plurality of blades, e.g. three blades. In this method, an activity signal is detected at subsequent time points for each blade. In an exemplary embodiment, the activity signals are blade frequencies resulting from vibrations of the respective blades. However, the activity signals may also refer to other kinds of signals detected for the respective blades, such as strain signals or moment signals. Strain signals may e.g. be detected by fibre optic strain gauges and moment signals may e.g. be calculated from detected strain signals. Furthermore, an activity signal may refer to a displacement or an acceleration of the corresponding blade, in the edgewise direction of the blade. The term detection is to be interpreted broadly. Particularly, the activity signal needs not be detected directly by a measurement but can also be derived from one or more measurements, e.g. from the measured signals of a G-sensor as described in the above-mentioned document US 2010/0209243 A1. In another embodiment, the activity signals in the form of blade frequencies may be detected by blade load sensors, where the blade frequencies are e.g. obtained by a phase lock loop (PLL) frequency estimation of the signals from the blade load sensors.

In the method of the present invention, the following steps are performed for each time point of at least some of the subsequent time points.

In a step a), an activity signal of each blade at the respective time point is predicted by a separate data-driven model, i.e. there is a separate data-driven model for each blade. The predicted activity signal is an output value of the respective data-driven model. One or more detected activity signals of blades other than the blade whose activity signal is the output value are input values of the respective data-driven model. The respective data-driven model has been learned by machine learning using training data comprising known input and output activity signals occurred in the past during an undamaged state of the wind turbine. In an exemplary embodiment, the learning of the data-driven model may be continued during monitoring of the wind turbine. In this case, the data-driven models are updated by machine learning at given time points using training data newly acquired during the operation of the wind turbine.

In a step b) of the method of the present invention, a residual between the predicted activity signal and the detected activity signal is determined for each data-driven model; e.g., the residual may be the difference or the absolute value of the difference between the predicted and the detected activity signals. Moreover, a residual may also refer to the square of this difference.

In a step c) of the method according to the present invention, a threshold criterion for one or more variables is checked, where the values of the one or more variables depend on the residuals for all data-driven models. This means that the values of the one or more variables as a whole depend on the residuals for all data-driven models. In other words, the value of a single variable may only depend on some residuals and needs not depend on the residuals for all data-driven models.

Based on the threshold criterion, a threshold is defined for each variable, where the threshold criterion is fulfilled if the value of any variable (i.e. at least one variable) exceeds the defined threshold. An appropriate choice of the thresholds lies within the expertise of a skilled person or can be determined by experiments. In an exemplary embodiment, the thresholds depend on the standard deviation of a frequency distribution of a time series of variable values as described below. In case that the value of any variable is equal to the threshold, this can be regarded as a case where the threshold criterion is fulfilled or, alternatively, as a case where the threshold criterion is not fulfilled.

In a step d) of the method according to the present invention, an abnormal operation state of the turbine is determined if the threshold criterion is fulfilled.

The present invention is based on the finding that a prediction of several learned data-driven models outputting the activity signal of a blade by inputs of activity signals of one or more other blades provides a reliable detection of an abnormal turbine state which is an indication of a damage which may result in a failure of the wind turbine in the near future.

In an exemplary embodiment, the detected activity signals are blade frequencies and blade edge frequencies resulting from the vibrations in the edgewise direction of the respective blades. The respective blade edge frequency is the fundamental frequency of the vibrations in the edgewise direction of the respective blade.

In another exemplary embodiment, the threshold for a respective variable depends on the standard deviation of a frequency distribution of a time series of values of the respective variable in the past, where the time interval of the time series does not cover the time interval of the training period of the data-driven models. The threshold lies between the standard deviation multiplied by two and the standard deviation multiplied by three. In a particularly exemplary embodiment, the threshold is the standard deviation multiplied by three. The above interval for choosing the respective threshold provides a particularly high reliability in detecting abnormal operation states.

In another exemplary embodiment, the one or more input values of the respective data-driven model comprise, additionally to the one or more detected activity signals of blades other than the blade which activity signal is the output value, one or more further environmental and/or operational parameters of the wind turbine, particularly an ambient temperature around the wind turbine and/or a power output of the wind turbine and/or a rotating speed of the wind turbine rotor and/or an azimuth angle of the respective blade and/or a pitch angle of the respective blade. The terms azimuth angle and pitch angle are well-known for a skilled person. The azimuth angle refers to the angle of the blade in a plane spanned by the blades of the turbine and the pitch angle refers to the angle the blade is facing towards the wind. The use of further inputs improves the fidelity of the predictions made by the data-driven models.

Any known data-driven models may be used in the method of the present invention; e.g., the respective data-driven models may be based on Gaussian processes and/or on a (artificial) neural network structure.

In another embodiment of the present invention, an alarm is recorded (i.e. stored in a corresponding storage) and/or an alarm is output via a user interface if an abnormal operation state of the turbine is determined, i.e. in case that the threshold criterion is fulfilled.

In a straightforward implementation of the present invention, the one or more variables processed in step c) of the method correspond to the residuals; i.e., the variables are identical with the residuals.

In another particular exemplary embodiment, a trend removal for removing a common trend in the time series of the residuals is applied to the residuals determined in step b), the result of the trend removal being the one or more variables processed in step c). Methods for trend removal are well-known for a skilled person; e.g., the trend removal may be based on cointegration, Auto-Associative Neural Networks or Principal Component Analysis.

In an exemplary variant of the embodiment, the trend removal is based on one or more cointegrated vectors, where the multiplication of the one or more cointegrated vectors with the residuals determined in step b) results in the one or more variables. Each cointegrating vector has been derived by cointegration applied to a time series of at least some residuals for different data-driven models occurred in the past during an undamaged state of the wind turbine. The time interval considered for cointegration is another time interval than the time interval comprising the data-driven model training period.

In another variant of the present invention, the trend removal is based on one or more transformations applied to the residuals determined in step b) and resulting in the one or more variables, each transformation having been derived by a Principal Component Analysis applied to a time series of at least two residuals for different data-driven models occurred in the past during an undamaged state of the wind turbine. The time interval of this time series is another time interval than the time interval comprising the data-driven model training period.

In another particularly exemplary embodiment, all possible pairs of residuals for different data-driven models are each processed by a separate trend removal procedure. This embodiment provides further information about the cause of a damage. Particularly, the blade which is damaged may be identified.

Besides the above method, the present invention refers to a system for computer-implemented monitoring of a wind turbine, the wind turbine comprising a tower, a nacelle, a hub and a plurality of blades, where for each blade an activity signal of the blade is detected at subsequent time points, where the system is configured to perform a method according to the present invention or a method according to one or more exemplary embodiments of the present invention.

The present invention also refers to a computer program product (non-transitory computer readable storage medium having instructions, which when executed by a processor, perform actions) with program code, which is stored on a non-transitory machine-readable carrier, for carrying out a method according to the present invention or a method according to one or more exemplary embodiments of the present invention, when the program code is executed on a computer.

The present invention also refers to a computer program with program code for carrying out a method according to the present invention or a method according to one or more exemplary embodiments of the present invention, when the program code is executed on a computer.

### BRIEF DESCRIPTION

Some of the embodiments will be described in detail, with reference to the following figures, wherein like designations denote like members, wherein:

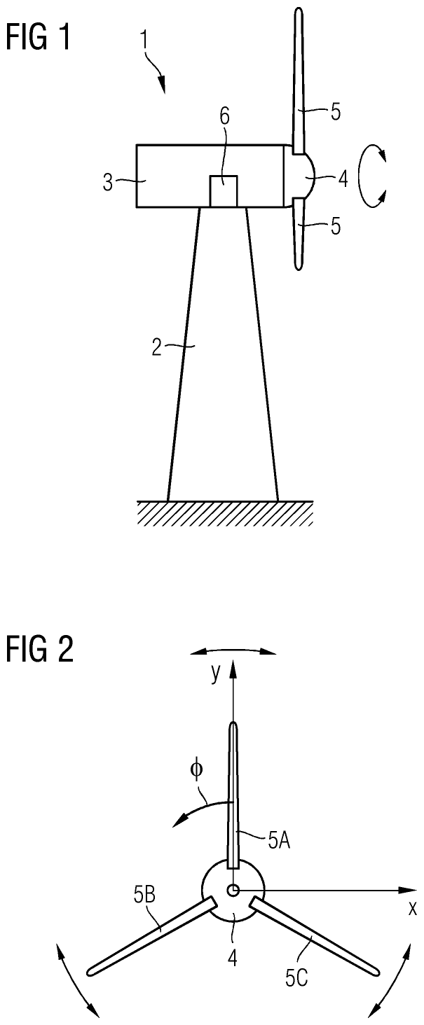

FIG. 1 depicts a wind turbine in a side view monitored based on an embodiment of the present invention;

FIG. 2 depicts the wind turbine of FIG. 1 in a front view; and

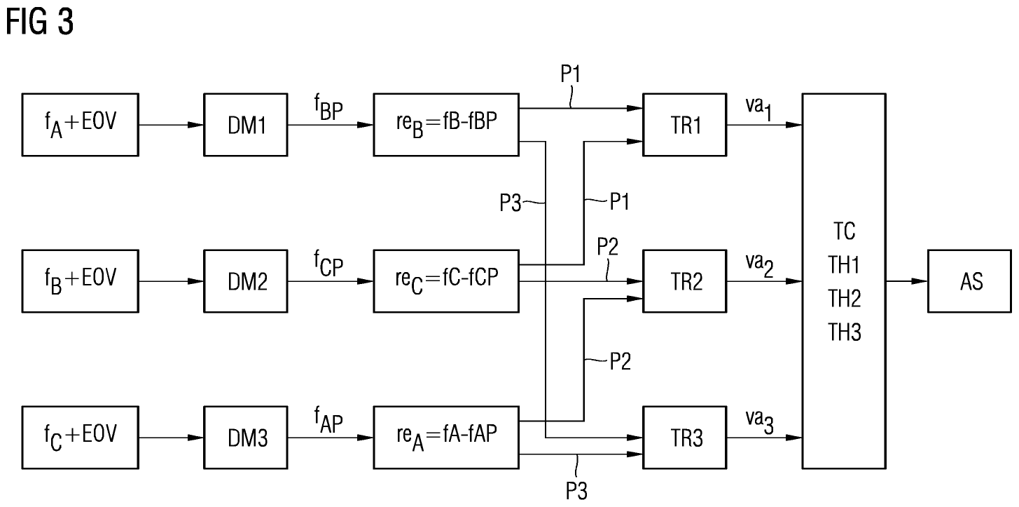

FIG. 3 is an illustration of the steps performed for monitoring the turbine of FIG. 1 based on an embodiment of the present invention.

### DETAILED DESCRIPTION

In the following, the present invention will be described based on a monitoring system for a wind turbine shown in FIG. 1 and FIG. 2. This turbine is designated in FIG. 1 with reference numeral 1 and comprises a tower 2 on the top of which a nacelle 3 is arranged. The nacelle is connected to a hub 4 at which three rotating blades 5 are attached. This can be seen in the front view of FIG. 2. According to this view, the three rotating blades are designated with different reference numerals 5A, 5B and 5C. These blades are offset by an angle of 120° and rotate around the hub. The position of the blades is given by the azimuth angle ϕ.

In FIG. 2, the flapwise direction extends perpendicular to the plane spanned by the x-axis and y-axis whereas the edgewise direction is the side-to-side direction of the blade edges as indicated by double arrows in FIG. 2. The blades are driven by wind resulting in the production of electric energy by an electric machine (not shown) rotated by the blades. The wind excitation on the turbine causes multiple vibrations on the turbine structures, including the blade in the edgewise direction as indicated by the double arrows. In the embodiment described herein, those edgewise vibrations are analyzed in order to determine the condition of the wind turbine.

In the wind turbine of FIG. 1 and FIG. 2, the vibrations of the blades in the edgewise direction are detected by a 3D acceleration sensor 6 also named G-sensor which is positioned within the nacelle 3. By analyzing the signals of this sensor, the fundamental blade edge frequency of the edgewise vibrations of each blade can be extracted. Methods for extracting those blade edge frequencies are well-known and use e.g. a PLL frequency estimation (PLL=Phased Locked Loop). Document US 2010/0209243 A1 describes a method for obtaining the blade edge frequencies by the signals of a G-sensor (a three-axis accelerometer). In the embodiment described herein, the fundamental blade edge frequencies are processed. However, the method may also be used with higher-order detected blade frequencies or other activity signals of the blades, such as strain signals or moment signals or displacement signals or acceleration signals of the corresponding blade as mentioned above.

FIG. 3 shows the steps which are performed by an embodiment of a monitoring system for monitoring the wind turbine 1 shown in FIG. 1 and FIG. 2. At subsequent time points, the blade edge frequency of each blade 5A, 5B, 5C is detected by analyzing the signals of the G-sensor. Those detected frequencies are designated as f_{A} for blade 5A, f_{B} for blade 5B and f_{C} for blade 5C. Moreover, at the respective time points at which the blade frequencies are detected, further environmental and operational variables of the turbine are detected. Those variables are designated in total by the term EOV in FIG. 3. The variables EOV comprise at least one and all of
the following variables:
the ambient temperature around the wind turbine;
the power output of the wind turbine;
a rotating speed of the wind turbine rotor;
the azimuth angle ϕ of the respective blade;
the pitch angle of the respective blade (i.e. the angle the blade is facing towards the wind).

For each of the detected blade edge frequencies together with the environmental and operational variables EOV, there exists a data-driven model. Those models are designated as DM1, DM2 and DM3. The data-driven model DM1 receives as inputs the blade edge frequency f_{A} together with the variables EOV. The data-driven model DM2 receives as inputs the blade edge frequency f_{B} together with the variables EOV. The data-driven model DM3 receives as inputs the blade edge frequency f_{C} together with the variables EOV.

The data-driven model DM1 is assigned to the blade 5B and predicts its blade edge frequency, i.e. the data-driven model DM1 outputs the predicted blade edge frequency f_{BP} of the blade 5B. The data-driven model DM2 is assigned to the blade 5C and outputs the predicted blade edge frequency f_{CP} of the blade 5C. The data-driven model DM3 is assigned to the blade 5A and outputs the predicted blade edge frequency f_{AP} of the blade 5A. The data-driven models DM1 to DM3 refer to well-known models which are learned by training data. In the embodiment described herein, the data-driven models are based on Gaussian processes.

The data-driven models have been learned before by machine learning based on training data of past operational values which have actually occurred (i.e. which have actually been detected) during operation of the wind turbine. Those training data form a time series of training data sets, where each training data set comprises the blade edge frequency and the environmental and operational variables input to the corresponding data-driven model as well as the blade edge frequency forming the output of the respective data-driven model. In order to distinguish between a healthy state and a damaged state of the turbine, the training data were only collected during a healthy state of the turbine. The time interval of the collected training data may e.g. be one year.

Based on the learned data-driven models DM1, DM2 and DM3 shown in FIG. 3, the respective blade edge frequencies of the blades, namely f_{BP}, f_{CP} and f_{AP}, are predicted for a given time point. At this time point, the actual blade edge frequency is also detected by analyzing the signals of the G-sensor 6. In a next step, the residual between the corresponding predicted blade edge frequency and the actual blade edge frequency is determined. In the embodiment described herein, this residual refers to the difference between the detected and predicted blade edge frequencies. However, the residual can also refer to the absolute value of this difference or to the square of this difference. In the embodiment of FIG. 3, the residuals are determined as follows:

re_{B}=f_{B}−f_{BP}

re_{C}=f_{C}−f_{CP}

re_{A}=f_{A}−f_{AP}

Residual re_{B} is with respect to the prediction of the blade edge frequency of blade 5B provided by data-driven model DM1. Residual rec is with respect to the prediction of the blade edge frequency of blade 5C provided by the data-driven model DM2. Residual re_{A} is with respect to the prediction of the blade edge frequency of blade 5A provided by data-driven model DM3.

An essential feature of the embodiment of FIG. 3 resides in the fact that the predicted blade edge frequencies output by the models use a blade frequency of another blade as an input. If there are no changes to the blade properties, the predicted frequencies will remain close to the actual detected frequencies so that the residual errors will remain low. If there are changes between the predicted frequencies and the actual detected frequencies, the residual will grow which means that there has been a change in the property of the blades which is an indication of the presence of damage.

In a straightforward implementation of the present invention, the residual errors may be used directly in order to identify an abnormal state of the wind turbine, i.e. a state which indicates a damage which may result in a failure of the turbine in the near future. To do so, a threshold may be defined directly for each residual and, in case that any of the residuals exceeds the threshold, an abnormal state will be detected. However, in order to enhance the diagnosis of the turbine, a normalization technique is implemented in the embodiment of FIG. 3. The aim of this normalization technique is to remove common trends between residuals. The normalization technique is based on the fact that non-stationarity is very common during the operation of a wind turbine since wind speeds, temperatures and other environmental and operational variables keep changing over the time. As those non-stationarities affect each blade equally, this allows the removal of a common trend.

In the embodiment of FIG. 3, three trend removal methods TR1, TR2 and TR3 (i.e. three instances of the same trend removal procedure) are used. Each of those methods provides a cointegrating vector which has been determined beforehand based on the well-known technique of cointegration. Cointegration is a common method in order to remove trends from data. The cointegration resulting in the cointegrating vectors of the trend removal methods TR1, TR2 and TR3 will be described later on in more detail.

In each of the trend removal methods TR1, TR2 and TR3, a vector having two entries of different residuals is processed. In other words, in the trend removal method TR1, a vector comprising the residuals re_{B} and re_{C} is processed, as indicated by arrows P1. In the trend removal method TR2, a vector comprising the residuals rec and re_{A} is processed, as indicated by arrows P2. In the trend removal method TR3, a vector comprising the residuals re_{B} and re_{A} is processed, as indicated by arrows P3. In the corresponding trend removal method, those vectors of residuals are multiplied with the cointegrating vector of the respective method.

For determining the respective cointegrating vectors, a time series of past pairs of residuals occurred during a normal operation of the turbine (i.e. in an undamaged state) are processed by cointegration. This cointegration will be described in the following where vectors are denoted in lowercase bold fonts and matrices are denoted in uppercase bold fonts. Cointegration is a well-known method. A description of cointegration is given in document Cross, Elizabeth J., Keith Worden, and Qian Chen. “Cointegration: a novel approach for the removal of environmental trends in structural health monitoring data.” Proceedings of the Royal Society of London A: Mathematical, Physical and Engineering Sciences. The Royal Society, 2011.

Let xₜ be a multivariate set of non-stationary measurements over time (the time is indicated by index t). In the embodiment of FIG. 3, those measurements refer to a time series of pairs of residuals determined in a past time interval which is another time interval than the time interval from which the training data of the data-driven models DM1, DM2 and DM3 originate. When using the terminology of FIG. 3, the vector xₜ is for the trend removal method TR1 a vector comprising the residuals re_{B} and rec at the corresponding time point, the vector xₜ is for the trend removal method TR2 a vector comprising the residuals re_{A} and rec at the corresponding time point, and the vector xₜ is for the trend removal method TR3 a vector comprising the residuals re_{A} and re_{B} at the corresponding time point.

The measurements xₜ are cointegrated if there exists a vector b that would yield a stationary signal zₜ via,

zₜ=b^{T}xₜ (1)

If such a solution exists, b is known as the cointegrating vector. This vector is determined beforehand in order to be used in the respective trend removal methods TR1, TR2 and TR3. Depending on the nature of a given set of non-stationary time series, there may exist more than one cointegrating vector, unique to uncertainty.

Prior to identifying the cointegrating vector, there exist some prerequisites. In addition to the fact that the signals in xₜ should share common trends, they should also be integrated to the same order. Here, the term “integrated to the same order” means that a non-stationary signal should be differenced n times before it becomes stationary and is denoted I(n); n is known as the order of integration.

In order to determine what the order of integration for a set of non-stationary signals is, a unit root test must be carried out. A unit root implies that the signal is intrinsically non-stationary. On the other hand, if the root is less than one, the signal is stationary, and if it is greater than one, the signal is a divergent process. The Augmented Dickey Fuller (ADF) test is commonly used to test for a unit root, where the null hypothesis is that the characteristic equation of a signal under consideration has at least one unit root. In the ADF test, the signal is fitted to a model of the form,

Δxₜ=αxₜ₋₁+Σⱼ₌₁^{p-1}βⱼΔxₜ₋ₜ₋ⱼ+εₜ (2)

where Δxₜ=xₜ−xₜ₋₁, and Δxₜ₋₁=xₜ₋₁xₜ₋ⱼ₋₁. The number of lags, p allows for high order autoregressive processes, and needs to be chosen such that εₜ becomes a white noise process. The Akaike, Bayesian, or Hannan-Quinn information criteria (AIC, BIC, or HQIC, respectively) can aid in finding the optimum number of lags. In the embodiment described herein, the AIC was used. The coefficient a is the focal point of the ADF test. In principle, if α is 0, the signal is intrinsically non-stationary and hence contains a unit root. In reality, it is impossible for α to be precisely 0, and hence the problem is to determine whether α is statistically close to 0. This is performed by calculating a test statistic given by equation (3), and comparing it to critical ADF test statistic values. The test statistic is calculated using,

$$\hat{t} = \frac{\hat{α}}{se ( \hat{α} )} \qquad ( 3 )$$

where \hat{α} is the estimate of a found using least squares, and se(\hat{α}) is its standard error. The null hypothesis of the ADF test is accepted if \hat{t}>t_{c}, where t_{c} is the critical value found in the ADF test statistics tables. In this case, the set of solutions of the characteristic equation of the signal contains a unit root. The process is repeated once more for the differenced signal Δxₜ. In the second iteration, if the null hypothesis is rejected, then the original signal is non-stationary, and is integrated to order one, i.e. I(1). In the event that the null hypothesis of the ADF test is accepted, the above process is repeated for further differenced signals until the order of integration of the signal is found.

Having evaluated the orders of integration for all the signals, the next task is to identify b. In this process, only signals that are integrated of the same order can be used. There are several methods that can be employed to identify b. These include the Engle-Granger approach and the Johansen procedure. In the embodiment described herein, the Johansen procedure is used. The Johansen procedure is concerned with only I(1) signals, but there are methods to identify b for higher integrated orders. The following briefly details the Johansen procedure.

The Johansen procedure begins by fitting the signals into a vector autoregressive model, which can be stated as,

xₜ=M₁xₜ₋₁+M₂Xₜ₋₂+ . . . +Mₚxₜ₋ₚ+εₜ

where M₁, M₂, . . . , Mₚ are weight matrices xₜ₋₁, xₜ₋₂, . . . xₜ₋ₚ are lag terms, and εₜ is a Gaussian noise process. This step is preformed so that the model order, p can be determined by a suitable information criterion, such as AIC, which will be used in the subsequent evaluations. The next step of the Johansen procedure is to fit the signals to a vector error correction model (VECM), which can be stated as,

Δxₜ=ΔB^{T}xₜ₋₁+Σⱼ₌₁^{p-1}θⱼΔxₜ₋ⱼ+εₜ (4)

where Δxₜ=xₜ−xₜ₋₁, θⱼ is a weight for the corresponding difference term, and A and B are matrices containing relevant weights. Of these two matrices, B is the most crucial, since it contains the potential cointegrating vectors b. Equation (4) needs to be manipulated further to extract B; this is broken down into two simpler regression,

Δxₜ=Σⱼ₌₁^{p-1}cⱼΔxₜ₋ⱼ+r₀ₜ (5)

and

xₜ₋₁=Σⱼ₌₁^{p-1}dⱼΔxₜ₋ⱼ+r₁ₜ (6)

The residuals, r₀ₜ and r₁ₜ are related as follows,

r₀ₜ=ΔB^{T}r₁ₜ+εₜ (7)

Next, some product-moment matrices are defined,

Sᵢⱼ=1/NΣₜ₌₁^{N}rᵢₜrⱼₜ for i,j=0,1 (8)

These product-moment matrices are then used to solve,

(λᵢS₁₁−S₀₁^{T}S₀₀⁻¹S₀₁)v₁=0 (9)

Equation (9) is an eigenvalue problem, with eigenvectors v₁ and eigenvalues λᵢ. The eigenvector corresponding to the largest eigenvalue in magnitude is the cointegrating vector b from the matrix B that provides the most stationary signal zₜ in equation (1). By multiplying this cointegrating vector in the respective trend removal methods TR1, TR2 and TR3 with the pair of residuals forming the input of the trend removal method, values of the variables va₁, va₂ and va₃ as shown in FIG. 3 are obtained.

The process of identifying the cointegrating vectors is carried out in a period when the data available originate from a wind turbine that is considered normal (or healthy). Once the cointegrating vectors are obtained, they should be kept unchanged, and new data should be projected onto these cointegrating vectors. If the wind turbine continues to be healthy, the signal zₜ will continue to be stationary. If, however, the wind turbine becomes damaged, the signal zₜ (i.e. the values of the variables va₁, va₂ and va₃) would become non-stationary.

As already mentioned above, the trend removal methods TR1, TR2 and TR3 provide values of variables va₁, va₂ and va₃. Those variables are subjected to a threshold criterion TC, where a threshold TH1 is defined for variable va₁, a threshold TH2 is defined for variable va₂ and a threshold TH3 is defined for variable va₃. In an exemplary embodiment, the thresholds are determined based on a time series of past values of the respective variables va₁, va₂ and va₃ in a predetermined time interval. The time interval lies outside the time interval used for training the data models and covers an operation of the wind turbine where the turbine is in a healthy state. The thresholds TH1, TH2 and TH3 are determined based on the standard deviation a of the frequency distribution of the values of the respective variables va₁, va₂ and va₃ in the considered time interval. The values for TH1, TH2 and TH3 lie between 2σ and 3σ of the respective frequency distribution. This choice ensures a reliable detection of an abnormal state of the wind turbine.

The threshold criterion TC is applied to the respective variables va₁, va₂ and va₃. The threshold criterion is fulfilled if a value of any of the variables va₁, va₂ and va₃ exceeds the corresponding threshold TH1 (for variable va₁), TH2 (for variable va₂) and TH3 (for variable va₃). When exceeding the corresponding threshold, this is an indication that the predictions learned from a healthy state of the turbine are no longer correct, i.e. this is an indication of an abnormal or damage state of the turbine which may result in a failure of the turbine in the near future. This abnormal state is designated as AS in FIG. 3.

In case that the method of FIG. 3 determines an abnormal state of the turbine, this will result in an alarm which is recorded and also output via a user interface of the monitoring system so that an operator is informed about the deterioration of the wind turbine. Appropriate measures can be taken, e.g. during maintenance.

In the embodiment of FIG. 3, it is also recorded which threshold or thresholds are exceeded in case that the threshold criterion is fulfilled. This enables to identify in more detail the damage; e.g. in case that only the thresholds TH1 and TH2 are exceeded, this will indicate a damage with respect to the blade 5C.

The present invention as described in the foregoing has several advantages. Particularly, the behavior of each blade in a wind turbine can be predicted, giving the performance of another blade, which forms a good baseline to compare with. Furthermore, non-stationary trends that can mask changes in blade properties are removed, resulting in an early and reliable damage detection of a turbine. Since fatigue damage/crack initiation and propagation occurs over a relatively long period of time, an abnormality can be determined very early with the method of the present invention based on the training of several data-driven models over healthy state data. Furthermore, environmental and operational variables which tend to obfuscate damages can be taken into account in the corresponding data-driven models as input, resulting in a more reliable detection of abnormal states.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

What is claimed:

1. A method for computer-implemented monitoring of a wind turbine, the wind turbine comprising a tower, a nacelle, a hub (II) and a plurality of blades, where for each blade an activity signal of the blade is detected at subsequent time points, where for each time point of at least some of the subsequent time points, the following steps are performed:
a) predicting an activity signal of each blade at the respective time point by a separate data-driven model , where the predicted activity signal is an output value of the respective data-driven model and where one or more activity signals of blades other than the blade whose activity signal is the output value are input values of the respective data-driven model and where the respective data-driven model has been learned by machine learning using training data comprising known input and output activity signals occurred in the past during an undamaged state of the wind turbine;
b) determining for each data-driven model a residual between the predicted activity signal and the detected activity signal;
c) checking a threshold criterion for one or more variables, where the values of the one or more variables depend on the residuals for all data-driven models, where a threshold is defined for each variable (hand the threshold criterion is fulfilled if the value of any variable exceeds the threshold defined for this variable; and
d) determining an abnormal operation state of the turbine, if the threshold criterion is fulfilled.

2. The method according to claim 1, wherein the detected activity signals are blade frequencies resulting from vibrations of the respective blades, blade edge frequencies resulting from the vibrations in the edgewise direction of the respective blades, the respective blade edge frequency being the fundamental frequency of the vibrations in the edgewise direction of the respective blade.

3. The method according to claim 1, wherein the threshold for a respective variable depends on the standard deviation of a frequency distribution of a time series of values of the respective variable in the past, where the threshold lies between the standard deviation multiplied by two and the standard deviation multiplied by three.

4. The method according to claim 1, wherein the one or more input values of a respective data-driven model comprise, additionally to the one or more detected activity signals of blades other than the blade whose activity signal is the output value, one or more further environmental and/or operational parameters of the wind turbine, particularly an ambient temperature around the wind turbine and/or a power output of the wind turbine and/or a rotating speed of the wind turbine rotor and/or an azimuth angle of the respective blade and/or a pitch angle of the respective blade.

5. The method according to claim 1, wherein the respective data-driven models are based on Gaussian processes and/or a neural network structure.

6. The method according to claim 1, wherein an alarm is recorded and/or output via a user interface if an abnormal operation state of the turbine is determined.

7. The method according to claim 1, wherein the one or more variables processed in step c) correspond to the residuals.

8. The method according to claim 1, wherein a trend removal for removing a common trend in the time series of the residuals is applied to the residuals determined in step b), the result of the trend removal being the one or more variables processed in step c).

9. The method according to claim 8, wherein the trend removal is based on one or more cointegrating vectors, where the multiplication of the one or more cointegrating vectors with the residuals determined in step b) results in the one or more variables, each cointegrating vector having been derived by cointegration applied to a time series of at least two residuals for different data-driven models occurred in the past during an undamaged state of the wind turbine.

10. The method according to claim 8, wherein the trend removal is based on one or more transformations applied to the residuals determined in step b) and resulting in the one or more variables, each transformation having been derived by a Principal Component Analysis applied to a time series of at least two residuals for different data-driven models occurred in the past during an undamaged state of the wind turbine.

11. The method according to claim 1, wherein all possible pairs of residuals for different data-driven models are each processed by a separate trend removal procedure.

12. A system for computer-implemented monitoring of a wind turbine, the wind turbine comprising a tower, a nacelle, a hub and a plurality of blades, where for each blade an activity signal of the blade is detected at subsequent time points, where the system is configured to perform for each time point of at least some of the subsequent time points a method comprising:
a) predicting an activity signal of each blade at the respective time point by a separate data-driven model, where the predicted activity signal is an output value of the respective data-driven model and where one or more detected activity signal of blades other than the blade whose activity signal is the output value are input values of the respective data-driven model and where the respective data-driven model has been learned by machine learning using training data comprising known input and output activity signals occurred in the past during a undamaged state of the wind turbine;
b) determining for each data-driven model a residual between the predicted activity signal and the detected activity signal;
c) checking a threshold criterion for one or more variables, where the values of the one or more variables depend on the residuals for all data-driven models, where a threshold is defined for each variable and the threshold criterion is fulfilled if the value of any variable exceeds the threshold defined for this variable; and
d) determining an abnormal operation state of the turbine, if the threshold criterion is fulfilled.

13. The system according to claim 12, wherein the system is configured to perform a method.

14. A computer program product, comprising a computer readable hardware storage device having computer readable program code stored therein, said program code executable by a processor of a computer system to implement the method according to claim 1 when the program code is executed on a computer.

15. A computer program with program code for carrying out a-the method according to claim 1 when the program code is executed on a computer.
